(19) United States
(12) Patent Application Publication
(10) Pub. No.: US 2013/0031731 A1
(43) Pub. Date: Feb. 7, 2013

(54) CLEANING DEVICE

(71) Applicant: Alfred Karcher GmbH & Co. KG, Winnenden (DE)

(72) Inventor: Stefan Hess, Leutenbach (DE)

(73) Assignee: Alfred Karcher GmbH & Co. KG, Winnenden (DE)

(21) Appl. No.: 13/645,648

(22) Filed: Oct. 5, 2012

Related U.S. Application Data
(63) Continuation of application No. PCT/EP2011/055124, filed on Apr. 1, 2011.

(30) Foreign Application Priority Data
Apr. 8, 2010 (DE) 10 2010 003 754.0

(51) Int. Cl. B08B 7/00

(52) U.S. Cl. 15/3

(57) ABSTRACT

A cleaning device is provided with a housing which has a placement surface for setting down a container and with travel wheels for moving the cleaning device. In order to develop the cleaning device further in such a manner that a container can be secured on the placement surface in a simple manner, it is suggested that the cleaning device have at least one storage space, in which at least one tensioning element is arranged in a storage position, this tensioning element being withdrawable from the storage space at least partially and being transferable into a working position for the purpose of securing the container on the placement surface.

### CROSS-REFERENCE TO RELATED APPLICATIONS

This application is a continuation of international application number PCT/EP2011/055124, filed on Apr. 1, 2011, and claims the benefit of German application number 10 2010 003 754.0, filed on Apr. 8, 2010, which are incorporated herein by reference in their entirety and for all purposes.

### BACKGROUND OF THE INVENTION

The invention relates to a cleaning device with a housing which has a placement surface for setting down a container and with travel wheels for moving the cleaning device.

Cleaning devices of this type are used, for example, in the form of vacuum cleaners or also in the form of high-pressure cleaning devices. They are utilized, for example, on building sites but also at other locations of use. The cleaning devices are equipped with travel wheels and can, therefore, be moved along a floor.

The cleaning devices are often positioned in a transport vehicle for the purpose of transporting them to a location of use. Often, the stowing space available in the transport vehicle is restricted. For this reason, containers are, in many cases, placed on the cleaning devices positioned in the stowing space, for example tool boxes or other containers which accommodate utensils or accessories. When the transport vehicle has reached its destination, the containers and the cleaning device will be removed from the transport vehicle and, subsequently, transported to the actual site of their use.

EP 0 916 302 B1 discloses a cleaning device in the form of a vacuum cleaner, the housing of which has on the upper side a placement surface with a recess, into which a container can be inserted. The container is, as a result, secured on the placement surface of the housing against shifting. In addition, the container can be locked in the recess with the aid of locking elements. The locking elements are designed as displaceable locking bars. The locking of the container to the placement surface has the advantage that the vacuum cleaner can be moved by the user together with the container in the form of a single transport unit. However, it is necessary for the container to have the dimensions of the recess. Containers and vacuum cleaners must, therefore, be adapted to one another in their dimensions. In addition, it is necessary for the purpose of locking the container for it to have fastening elements interacting with the locking elements.

The object of the present invention is to further develop a cleaning device of the type specified at the outset in such a manner that a container can be secured on the placement surface in a simple manner.

### SUMMARY OF THE INVENTION

This object is accomplished in accordance with the invention, in a cleaning device of the generic type, in that the cleaning device has at least one storage space, in which at least one tensioning element is arranged in a storage position, this tensioning element being withdrawable from the storage space at least partially and transferable into a working position for the purpose of securing the container on the placement surface.

For the purpose of securing the container on the placement surface of the housing, the cleaning device has at least one tensioning element which is arranged in a storage position in a storage space provided by the cleaning device. The tensioning element can be withdrawn from the storage space at least partially and transferred into a working position for the purpose of securing a container on the placement surface. Since it is carried along by the cleaning device in the storage space, it is available to a user at any time for securing a container or also any other object on the placement surface. After use, the tensioning element can be brought back into the storage space again, in which it can be stored.

It may be provided for the cleaning device to have only a single storage space, in which a single tensioning element is arranged in a storage position. However, it may also be provided for the cleaning device to comprise several storage spaces which each accommodate a tensioning element. In addition, it may be provided for several tensioning elements to be arranged in at least one storage space of the cleaning device in a storage position, from which they can be transferred into a working position.

It is favorable when the at least one storage space is arranged beneath the placement surface. This offers the possibility of fixing the container, which has been set down on the placement surface, in position on the placement surface by means of the at least one tensioning element in a constructionally simple manner. The tensioning element can, for this purpose, be withdrawn from the storage space arranged beneath the placement surface at least to such an extent that the container can be fixed in place on the placement surface by means of the tensioning element. For example, the container can have the tensioning element engaging around it at least partially in circumferential direction.

The placement surface is preferably arranged on the upper side of the housing. This facilitates the positioning of the container on the placement surface.

In one advantageous embodiment of the cleaning device according to the invention, the tensioning element is adapted to be pulled at least partially out of the storage space. This facilitates the handling of the tensioning element.

It is of advantage when the tensioning element is adapted to be pulled at least partially out of the storage space contrary to the action of a restoring force.

The tensioning element is favorably elastically extendable. The tensioning element can preferably be stretched by at least 50%, i.e. the length of the tensioning element can be increased by at least 50% as a result of a stretching load. It is particularly favorable when the tensioning element can be stretched by 100%, i.e. can be stretched to double its length as a result of a stretching load.

A particularly simple handling during securing of a container on the placement surface of the housing results in one advantageous embodiment due to the fact that the tensioning element has a first end which is secured in the storage space as well as a second loose end which is accessible from outside the storage space. The tensioning element can be grasped by the user at its loose end and then withdrawn at least partially from the storage space. The end of the tensioning element facing away from the loose end is secured in the storage space. The user can guide the loose end around the container set down on the placement surface and fasten it to the cleaning device or also to the container.

It has proven to be favorable, particularly when two tensioning elements are used, when they are each fixed in a storage space with one end and can be grasped by the user at their other end and pulled out of the storage space.

A fastening element, for example a fastening hook, is preferably arranged at the loose end of the at least one tensioning element. In a working position, the tensioning element can be secured on the cleaning device or on the container in a simple manner with the aid of the fastening element in order to secure the container on the placement surface.

The tensioning element can be designed as a type of tensioning belt or a tensioning rope.

The at least one tensioning element is, in one advantageous embodiment of the invention, arranged in the storage space in the form of an elongated component.

Alternatively, it may be provided for the at least one tensioning element to be wound onto a spool in the storage space.

The at least one storage space of the cleaning device according to the invention is preferably of a channel-shaped configuration.

It may be provided for the housing of the cleaning device to have a cover plate which forms the placement surface on its upper side and into which the at least one storage space is integrated.

The cover plate is favorably arranged on an upper part of the housing of the cleaning device. The cover plate can preferably be releasably connected to the upper part of the housing.

The cover plate preferably has, at an edge of the placement surface, at least one stop element with a stop surface which projects beyond the placement surface, wherein the container can abut on the stop surface. This facilitates the positioning of the container on the placement surface. Favorably, at least one stop element is arranged at respective edges of the placement surface facing away from one another and the stop surfaces of these stop elements face one another.

It is of particular advantage when the cover plate has an underside which faces away from the placement surface and into which the at least one storage space is integrally formed. As a result, the production costs can be kept low.

It may, for example, be provided for the at least one storage space to form a receiving channel which is integrally formed in the underside of the cover plate. The receiving channel can have, for example, a U-shaped or C-shaped course in a view of the underside of the cover plate. In one preferred configuration of the invention, the tensioning element can be pulled at least partially out of the receiving channel in the longitudinal direction of the channel

It is favorable when the receiving channel opens into a side surface, preferably into a front side, of the cover plate. The tensioning element can be grippable by the user in its storage position in the opening area of the receiving channel.

It is of advantage when the cleaning device has fastening elements, to which the tensioning element can be secured in its working position. The fastening elements can be designed, for example, in the form of fastening eyes or fastening hooks, to each of which the tensioning element can be fastened with one end once it has been guided around a container placed on the placement surface.

The cleaning device preferably has a handle as this makes moving the cleaning device along the floor easier. In this respect, it is favorable when at least one fastening element for the tensioning element is arranged on the handle. The handle can preferably take up a position which is aligned at right angles to the placement surface and, as a result, laterally support the container which is set down on the placement surface. Several fastening elements, to each of which a tensioning element can be attached with one end, can favorably be arranged on the handle. The fastening elements, for example fastening eyes or hooks, are advantageously arranged at different distances in relation to the placement surface. This facilitates the securing of containers of different sizes by means of the tensioning element.

It is of particular advantage when the cleaning device, together with a container arranged on the placement surface, can be pivoted about a common axis of rotation of two travel wheels. The cleaning device can then be moved together with the container in the manner of a wheelbarrow. The container can be reliably fixed in place on the placement surface by means of the at least one tensioning element and can be moved together with the cleaning device.

It is favorable when the cleaning device is portable. This facilitates the transport of the cleaning device on uneven floors or also over steps.

It is of advantage when the cleaning device has a device handle pivotable into the placement surface. In a non-operational position, the device handle can be pivoted into the placement surface, wherein it does not then project out of the placement surface and a container can be set down on the placement surface without being affected by the device handle. Insofar as no container is positioned on the placement surface, the device handle can be pivoted out of the placement surface into an operational position, in which it can be grasped by the user in order to carry the cleaning device, for example, over a step.

In one particularly preferred embodiment, the cleaning device has at least one snap-in hook for locking a carrying handle of a container placed on the placement surface. This makes it possible to secure the container not only by means of the at least one tensioning element but, in addition, the container can be secured on the placement surface with the aid of the at least one snap-in hook. The snap-in hook interacts with a carrying handle of the container. The container can be set down on the placement surface in such an orientation that its carrying handle can interact with the at least one snap-in hook of the cleaning device. In particular, it may be provided for the snap-in hook to engage over the carrying handle of the container in a snap-in position. For this purpose, the carrying handle of the container can be pivoted over the snap-in hook, wherein the snap-in hook is, first of all, deformed in the direction away from the carrying handle of the container until the carrying handle takes up a position beneath the free end of the snap-in hook so that the snap-in hook can take up a snap-in position, in which it engages over the carrying handle of the container.

The cleaning device favorably comprises two snap-in hooks which are, in particular, of an identical design, interact with the carrying handle of the container set down on the placement surface and engage over it in a snap-in position.

The at least one snap-in hook is preferably arranged at an edge of the placement surface, wherein it projects beyond the placement surface.

In one particularly preferred configuration of the invention, the at least one receiving space opens into a side surface of the cleaning device, wherein a loose end of the tensioning element can be grasped by the user in the opening area of the receiving space and a snap-in hook, which interacts with the carrying handle of a container set down on the placement surface in order to form a snap-in connection, is arranged adjacent to the opening area. This has the advantage that following interlocking of the carrying handle with the snap-in hook the tensioning element can be guided over the carrying handle of the container and, as a result, the carrying handle can be acted upon with a force in the direction towards the snap-in hook. As a result, the container can be secured on the placement surface in a particularly reliable manner without there being any risk of the container slipping.

The following description of a preferred embodiment of the invention serves to explain the invention in greater detail in conjunction with the drawings.

### BRIEF DESCRIPTION OF THE DRAWINGS

FIG. 1 shows a perspective illustration of a cleaning device with a cover plate which forms a placement surface for one or also several containers;

FIG. 2 shows a perspective illustration of the cover plate from FIG. 1 at an angle from above;

FIG. 3 shows a view of the underside of the cover plate from FIG. 2; and

FIG. 4 shows a perspective illustration of the cleaning device from FIG. 1, wherein two containers are arranged on the placement surface one on top of the other and are fixed in place by means of two tensioning elements.

### DETAILED DESCRIPTION OF THE INVENTION

A cleaning device according to the invention is illustrated schematically in the drawings in the form of a vacuum cleaner 10 with a base 12, on which two travel wheels are mounted so as to be freely rotatable about a common axis of rotation 16. In order to achieve a better overview, only a first travel wheel 14 is illustrated in the drawings. In addition, two support wheels are rotatably mounted on the base 12, wherein only a first support wheel 18 is apparent in the drawings. The vacuum cleaner 10 can be moved along a floor surface by means of the travel wheels 14 and the support wheels 18.

A vacuum unit 20 is placed on the base 12 and this has a housing lower part 22 and a housing upper part 24. The lower part 22 of the housing forms, in the customary manner, a dirt collecting container, into which suction air can be drawn in via a suction inlet 26 together with suction material. A suction hose, which has a suction nozzle at its free end, can be connected to the suction inlet 26 in the customary manner. Such suction hoses and suction nozzles are known per se to the person skilled in the art and are not, therefore, illustrated in the drawings in order to achieve a better overview.

The upper part 24 of the housing surrounds, in the customary manner, a suction turbine which is driven by an electric motor. The dirt collecting container of the lower part 22 of the housing can be acted upon with a vacuum by means of the suction turbine.

A cover plate 30, which is connected releasably to the upper part 24 of the housing, is arranged on the upper part 24 of the housing and this is essentially of a rectangular shape and has a first longitudinal side 31, a second longitudinal side 32 facing away from the first longitudinal side 31 as well as a front side 33 and a rear side 34. A recess 36, which is essentially U-shaped in the plan view, is integrally formed in the front side 33 in the center.

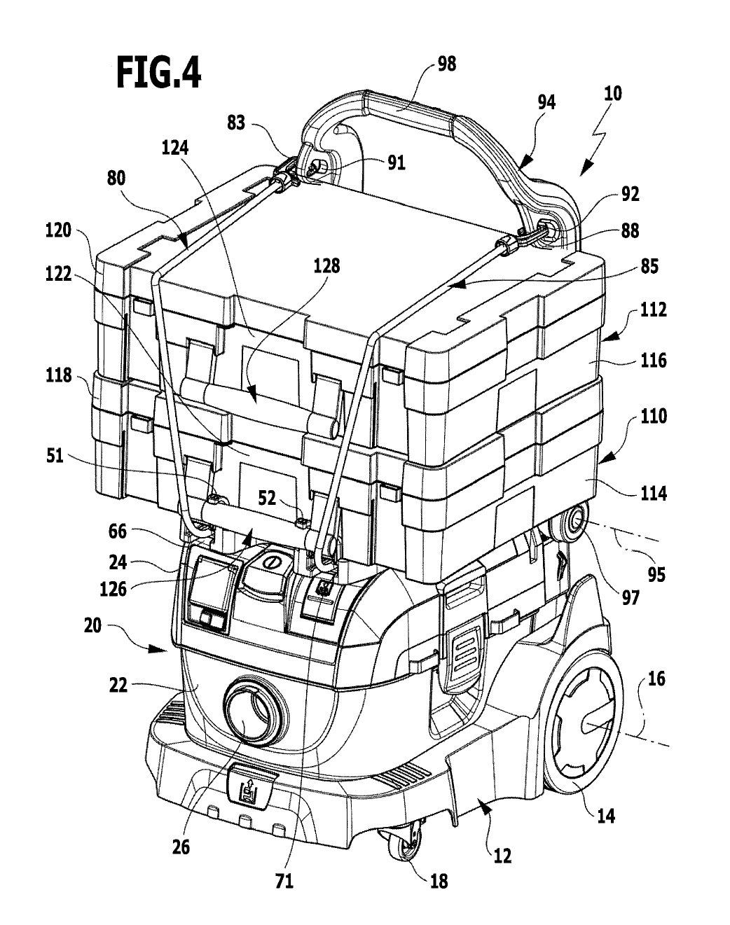

The cover plate 30 has an upper side which forms a placement surface 38 for the placement of one or more containers. This is apparent from FIG. 4. Moreover, the cover plate 30 has an underside 40 which faces away from the placement surface 38 and with which it rests on the upper part 24 of the housing.

At the rear-side edge of the placement surface 38, the cover plate 30 has on its upper side a first stop 42 which projects out of the placement surface 38 and has a first stop surface 43 aligned essentially at right angles to the placement surface 38. Between the recess 36 and the first longitudinal side 31 the cover plate 30 has at the front-side edge of the placement surface 38 on its upper side a second stop 45 which projects out of the placement surface 38 and has a second stop surface 46 aligned essentially at right angles to the placement surface 38, and between the recess 36 and the second longitudinal side 32 the cover plate 30 has at the front-side edge of the placement surface 38 on its upper side a third stop 48 which projects out of the placement surface 38 and has a third stop surface 49 aligned essentially at right angles to the placement surface 38. The second stop surface 46 faces the first stop surface 43, likewise the third stop surface 49.

A first snap-in hook 51 projects out of the placement surface 38 at the front-side edge of the placement surface 38 between the second stop 45 and the recess 36 and a second snap-in hook 52, which is of an identical design to the first snap-in hook 51, projects out of the placement surface 38 at the front-side edge of the placement surface 38 between the recess 36 and the third stop 48. Both snap-in hooks 51 and 52 face away from the first stop surface 43 and are elastically deformable.

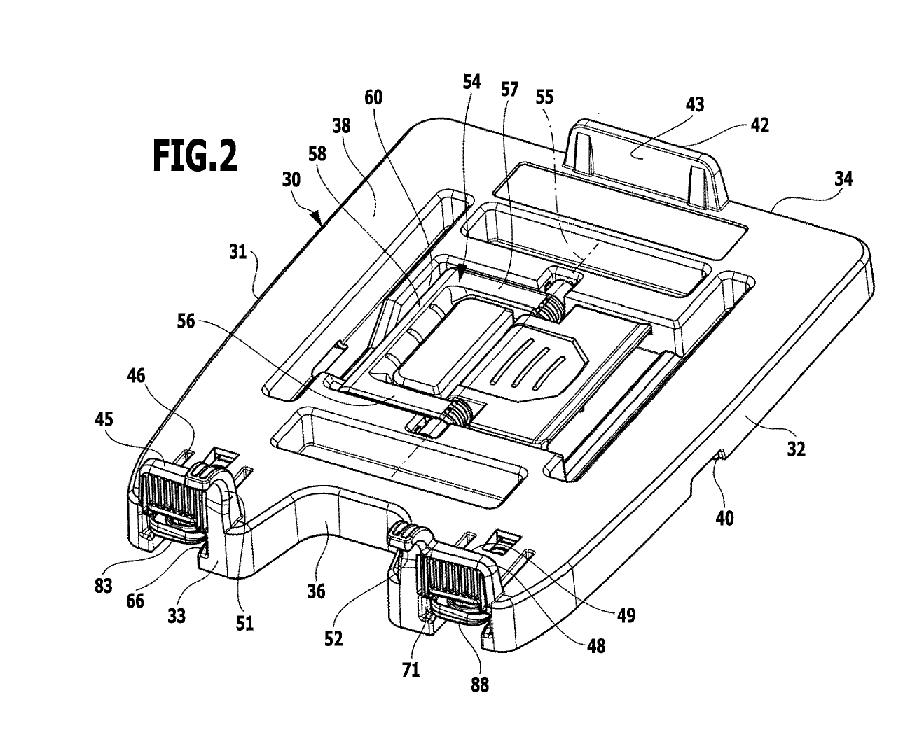

A device handle 54 is mounted in the placement surface 38 so as to be pivotable about a pivot axis 55. The device handle 54 is essentially of a U-shaped design and comprises a first arm 56 and a second arm 57 which are connected to one another in one piece at their free ends via a device crosspiece 58. In its non-operational position illustrated in FIG. 2, the device handle 54 is accommodated by a handle recess 60 which is integrally formed in the placement surface 38 on its upper side and out of which it can be pivoted into an operational position aligned at right angles to the placement surface 38 for the purpose of carrying the vacuum cleaner 10.

A first storage space in the form of a first receiving channel 62 and a second storage space in the form of a second receiving channel 64 are integrally formed in the underside 40 of the cover plate 30. The first receiving channel 62 opens into the front side 33 of the cover plate 30 beneath the second stop 45 and forms a first opening 66 in this region. Proceeding from the first opening 66, the first receiving channel 62 extends with a first channel section 67 in the direction of the rear side 34. The first channel section 67 is followed at a short distance from the rear side 34 by a second channel section 68 which extends parallel to the rear side 34 and is followed by a third channel section 69 which extends parallel to the second longitudinal side 32 and ends at a channel end 70 approximately at the level of the center of the second longitudinal side 32.

The second receiving channel 64 opens into the front side 33 of the cover plate 30 beneath the third stop 48 and forms a second opening 71 in this region. Proceeding from the second opening 71, the second receiving channel 64 extends with a first channel section 72 in the direction of the rear side 34. The first channel section 72 is followed at a short distance from the rear side 34 by a second channel section 73 which extends parallel to the rear side 34 and is followed by a third channel section 74 which extends parallel to the first longitudinal side 31 and ends at a channel end 75 approximately at the level of the center of the first longitudinal side 31.

The first receiving channel 62 accommodates a first, elastically extendable tensioning element 80 which is secured with a first end 81 to the channel end 70 of the first receiving channel 62 and dips with a second end 82 into the first opening 66. A fastening element in the form of a first fastening hook 83 is secured to the second end 82.

The second receiving channel 64 accommodates a second tensioning element 85 which is secured with a first end 86 to the channel end 75 of the second receiving channel 64 and the second end 87 of which dips into the second opening 71. A fastening element in the form of a second fastening hook 88 is secured to the second end 87.

The two tensioning elements 80 and 85 are accommodated completely in the respective receiving channel 62 and 64 in their storage position. With their second ends 82, 87 the tensioning elements 80 and 85 are, however, accessible for the user at the front side 33 of the cover plate 30. The first fastening hook 83 and the second fastening hook 88 can be grasped by the user at the front side 33. The tensioning elements 80 and 85 can then be stretched in longitudinal direction, wherein they can each be stretched by 100%, i.e. they can double their length. This offers the possibility of engaging around one or more containers, which have been placed on the placement surface 38, with the tensioning elements 80 and 85 at least partially in circumferential direction. The fastening hooks 83 and 88 can then each be hooked to a fastening eye 91 and 92, respectively. This is apparent from FIG. 4.

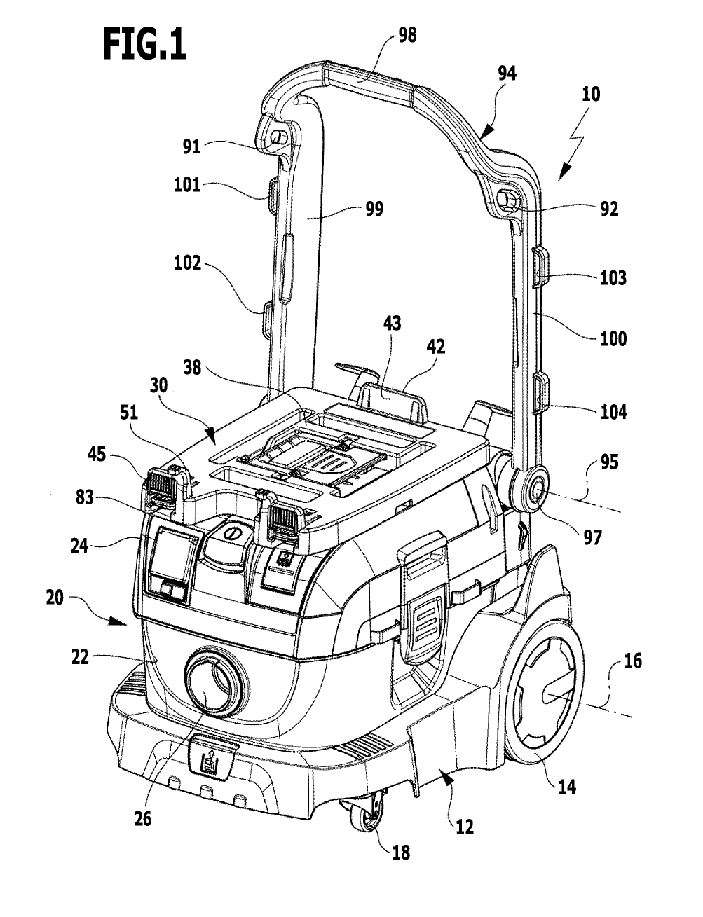

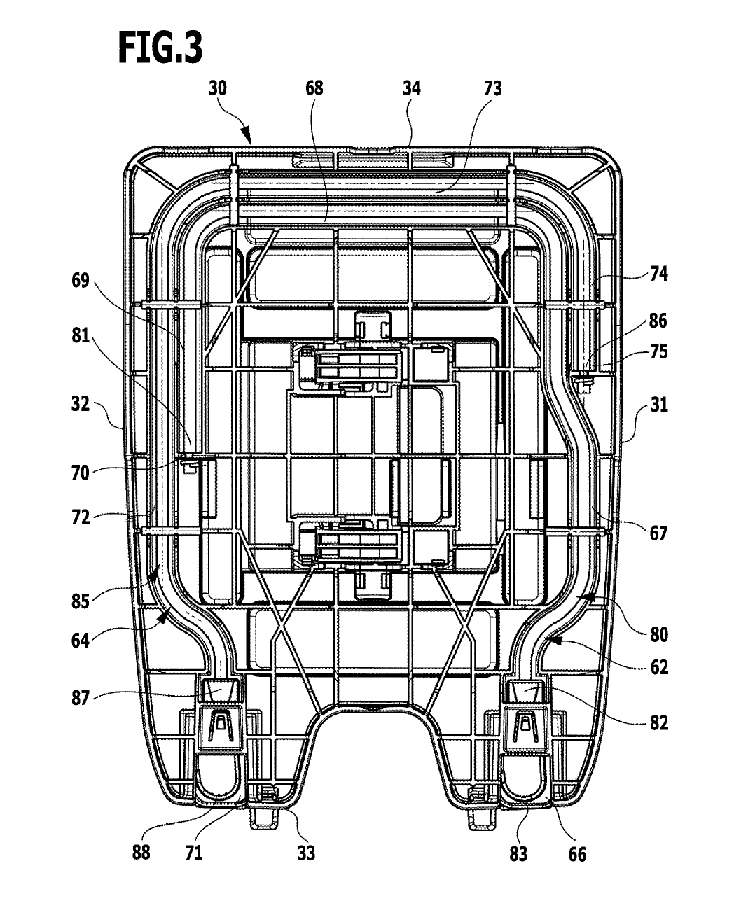

The fastening eyes 91 and 92 are arranged on a handle 94 which is essentially U-shaped, is mounted on the upper part 24 of the housing in a rearward area so as to be pivotable about a pivot axis 95 and has a first arm 99 as well as a second arm 100 which are connected to one another via a handle crosspiece 98. It can be pivoted back and forth between a pivoted out or upright position, which is illustrated in FIGS. 1 and 3, into a pivoted in position, which is not illustrated in the drawings and in which it is aligned parallel to the placement surface 38. The handle 94 can be locked in its pivoted out position by means of a locking device 97 which is arranged at the free end of at least one arm of the handle 94.

In addition to the fastening eyes 91 and 92, two additional fastening eyes 101, 102 and 103, 104, respectively, are integrally formed on each of the two arms 99, 100 at different distances to the placement surface 38.

The tensioning elements 80, 85 can, therefore, be secured to the handle 94 with their fastening hooks 83, 88 at different distances to the placement surface 38. As a result, containers of different sizes can be fixed in place on the placement surface 38 in a simple manner by means of the elastically extendable tensioning elements 80, 85.

In FIG. 4, the two tensioning elements 80, 85 are each illustrated in their working position, in which they engage around two containers 110, 112 which are arranged one on top of the other and set down on the placement surface 38. The two containers 110, 112 are of an identical design in the embodiment illustrated. They each comprise a container lower part 114 and 116, respectively, and a container cover 118 and 120, respectively, which is held on the container lower part 114, 116 so as to be pivotable. A carrying handle 126 and 128, respectively, is articulatedly mounted on a front side 122 and 124, respectively, of the container lower part 114, 116. The carrying handle 126 of the lower container 110 has the snap-in hooks 51, 52 engaging over it. This provides for an additional locking of the lower container 110 on the placement surface 38. The snap-in hooks 51, 52 are elastically deformable and so the carrying handle 126 snaps into a snap-in position, which is illustrated in FIG. 4 and in which the snap-in hooks 51, 52 engage over the carrying handle 126 of the container, by pivoting over the snap-in hooks 51, 52 once the lower container 110 has been set down on the placement surface 38.

The tensioning elements 80 and 85 can be pulled out of the receiving channels 62, 64 to such an extent that the two containers 110, 112 have the tensioning elements 80, 85 engaging over them in the region of the front sides 122, 124 and in the region of the upper container cover 120. On the rear side, the two containers 110, 112 are supported by the arms 99, 100 of the handle 94 and so they experience, altogether, a reliable fixing in place on the placement surface 38.

The containers 110, 112 secured on the placement surface 38 can be pivoted to the rear about the axis of rotation 16 of the two wheels 14 together with the vacuum cleaner 10 in the form of a single transport unit and so the containers 110, 112 can be moved along a floor together with the vacuum cleaner 10 in the manner of a wheelbarrow.

Once the containers 110, 112 have been removed from the placement surface 38, the two tensioning elements 80, 85 can be stowed again in the receiving channels 62, 64. On account of the elastic returning force of the tensioning elements 80, 85, they return to their storage position automatically after being released from the fastening rings 91, 92.

1. A cleaning device with a housing having a placement surface for setting down a container and with travel wheels for moving the cleaning device, wherein the cleaning device has at least one storage space, at least one tensioning element being arranged in said storage space in a storage position, said tensioning element being withdrawable from the storage space at least partially and being transferable into a working position for the purpose of securing the container on the placement surface.

2. The cleaning device as defined in claim 1, wherein the at least one storage space is arranged beneath the placement surface.

3. The cleaning device as defined in claim 1, wherein the tensioning element is adapted to be pulled out of the storage space at least partially.

4. The cleaning device as defined in claim 1, wherein the tensioning element is elastically extendable.

5. The cleaning device as defined in claim 1, wherein the tensioning element has an end secured in the storage space as well as a loose end accessible from outside the storage space.

6. The cleaning device as defined in claim 5, wherein a fastening element is arranged at the loose end of the tensioning element.

7. The cleaning device as defined in claim 1, wherein the tensioning element is arranged in the storage space in the form of an elongated component.

8. The cleaning device as defined in claim 1, wherein the at least one storage space is of a channel-shaped configuration.

9. The cleaning device as defined in claim 1, wherein the housing has a cover plate forming the placement surface on its upper side, wherein the at least one storage space is integrated into the cover plate.

10. The cleaning device as defined in claim 9, wherein the at least one storage space is integrally formed in an underside of the cover plate.

11. The cleaning device as defined in claim 1, wherein the at least one storage space is designed as a receiving channel.

12. The cleaning device as defined in claim 1, wherein the cleaning device has at least one fastening element, the tensioning element being securable to said fastening element in its working position.

13. The cleaning device as defined in claim 12, wherein the cleaning device has a handle, at least one fastening element being arranged on said handle.

14. The cleaning device as defined in claim 1, wherein the cleaning device is portable.

15. The cleaning device as defined in claim 1, wherein the cleaning device has at least one snap-in hook for locking a carrying handle of a container that is set down on the placement surface.

16. The cleaning device as defined in claim 15, wherein the at least one snap-in hook is arranged at an edge of the placement surface and projects beyond the placement surface.
